(19) United States
(12) Patent Application Publication
(10) Pub. No.: US 2008/0045170 A1
(43) Pub. Date: Feb. 21, 2008

(54) Favorite artist/song title feature ("FAST")

(76) Inventors: Stephen Howley, Marshfield, MA (US); Elizabeth Howley, Marshfield, MA (US)

Correspondence Address: Stephen Howley, 122 Marginal Street, Marshfield, MA, 02050, US

(21) Appl. No.: 11/504,384

(22) Filed: Aug. 15, 2006

(51) Int. Cl. H04H 7/00; H04B 1/18

(52) U.S. Cl. 455/186.1; 455/3.06

(57) ABSTRACT

A method of selecting a favorite artist/song title from a plurality of programs being transmitted from one or more remote locations and includes the step of storing a designator for the favorite artist/song title. A plurality of channels are scanned to determine if the favorite artist/song title is currently playing on at least one of the channels. An indication is provided when a favorite artist/song title is found to be playing on at least one of the channels. A listener can then select the favorite artist/song title playing real-time on a different radio frequency.

### FIELD OF THE INVENTION

The invention relates generally to the field of radio.

### BACKGROUND OF THE INVENTION

Modern radios offer several features to enhance the listening experience.

One such feature is the seek button. When the seek button is pressed, the radio automatically scans the airwaves and seeks out the next identifiable radio signal, either at a higher or lower frequency, from a broadcast source. When the seek function locates a radio signal of significant strength to be processed by the radio, it stops on that station and the listener hears the content of the broadcast.

There are, however, several limitations with the seek function, including listening to unappealing programming, repeatedly pressing the seek button to look for other program options and loss of listening time as the user seeks out appealing programming.

Another modern radio feature is the scan function. When the scan button is pressed the radio automatically scans the airwaves and seeks out the next identifiable radio signal, either at a higher or lower frequency, from a broadcast source. When the scan function locates a radio signal of significant strength to be processed by the radio, it stops on that station and the listener hears the content of the broadcast. The radio listener then has approximately five (5) seconds to determine whether or not they like that program. If the listener likes the program, they press the scan button again which disables the scan function and the radio will remain on that station. If the listener does not like the program, the listener does nothing and, after approximately five (5) seconds, the radio automatically scans the airwaves and seeks out the next identifiable radio signal. The radio continues to scan until the listener presses the scan button to disable the scan feature.

As with the seek function, however, there are several limitations with the scan function. One problem with the scan function is that with the large number of radio stations available, particularly in urban areas, it can take the listener significant time to scan through all of the available stations. Also, the listener is required to listen to programming content that may not be appealing to them.

Every radio listener has experienced tuning to a particular radio station only to hear the last 10 seconds of one of their favorite songs. Currently, there is no feature offered with radio listening that allows a listener to quickly and easily locate a favorite artist/song title that is playing real-time on the radio.

### SUMMARY OF THE INVENTION

The present invention is directed to solve one or more of the problems set forth above. Briefly summarized, according to one aspect of the present invention, a method of selecting a favorite artist/song title from a plurality of broadcasts being transmitted from one or more remote locations and includes the step of storing a designator for the favorite artist/song title. A plurality of channels are scanned to determine if a favorite artist/song title is currently playing on at least one of the channels. An indication is provided when a favorite artist/song title is found to be playing on at least one of the channels. The listener then has the option to retune their radio to a favorite artist/song title.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a front view of a portion of a radio showing a first embodiment of the invention;

FIG. 2 is a logic function that is used with the radio of FIG. 1;

FIG. 3 is another logic function that is used with the radio of FIG. 1.

### DETAILED DESCRIPTION OF THE INVENTION

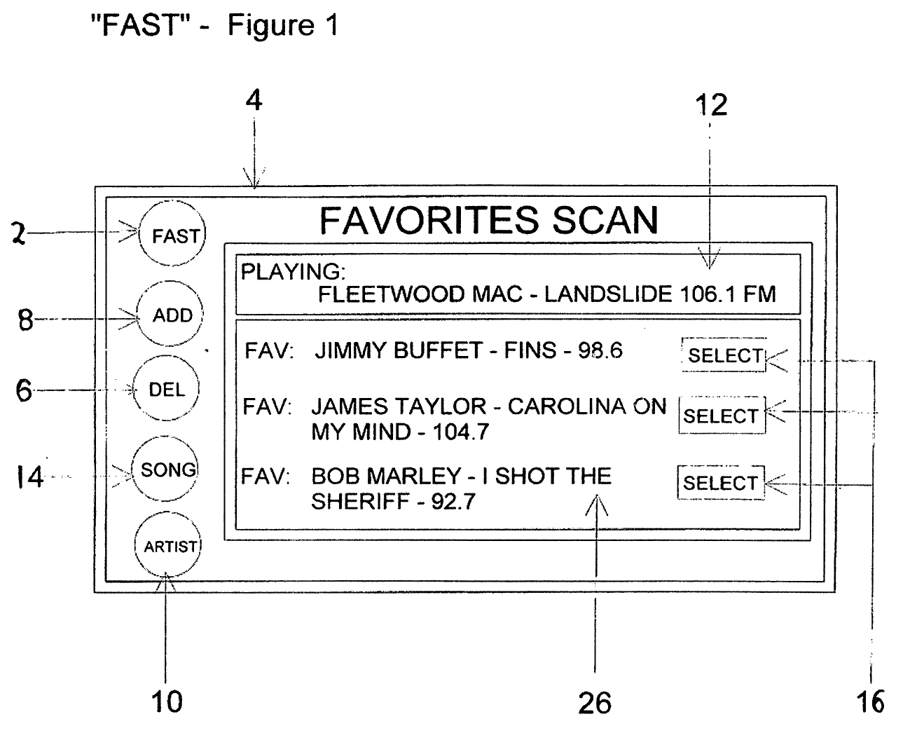

Beginning with FIG. 1, a portion of a radio 4 is shown. Other portions of the radio, which include controls for volume, tone and station pre-sets are not shown in order to simplify the explanation of this embodiment. Many modern radios display the name of the artist and song title for the current program that is being broadcast from a remote location and played on the radio. This information is broadcast by the radio station in conjunction with the audio program being transmitted.

A display 12 presents various information to the listener about the current radio program playing. In this embodiment the musical group (“Fleetwood Mac”), the song title (“Landslide”), the radio frequency (“106.1”) and the frequency band (FM) are shown. If the program was a talk show, other information such as the name of the show and the host are displayed. While the radio is tuned as described above, the listener can now add the content of the programming by pressing the ADD button 8. Once the ADD button is pressed, the listener chooses to add either the artist (“Fleetwood Mac”), button 10 or the song title (“Landslide”), button 14 to their Favorites List. If they add the Artist, then any song performed by the Artist will be identified as a Favorite Song. If they add the song title, only the song title is identified as a Favorite Song.

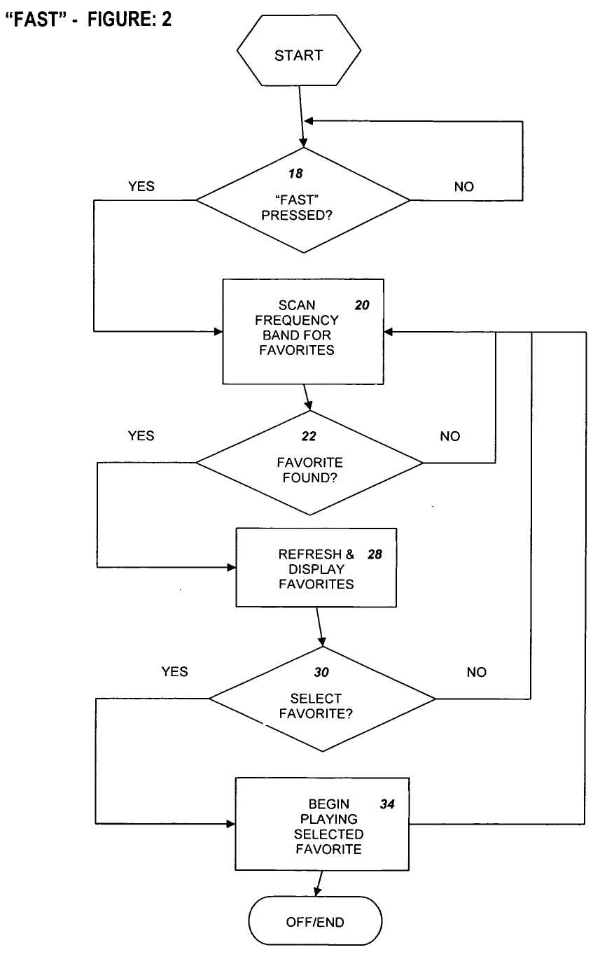

Referring now to FIGS. 1 and 2, the operation of finding a “Favorite Artist/Song Title” (“FAST”) function will be explained. When the radio is powered on the logic sequence in FIG. 2 is commenced. At a decision point 18 it is determined whether or not the “FAST” button 2 has been pressed. If button 2 has not been pressed the logic loops back above decision point 18. If button 2 has been pressed, the logic proceeds to a box 20 and begins to scan the frequency bands looking to see if a stored favorite artist/song title is playing on one of the radio channels. If at a decision point 22 it is determined that a stored favorite has not been found after a complete scan of the current frequency band, the logic loops back to box 20 and continues to scan for Favorites while the radio continues playing the current broadcast. A visual indicator on display 26 such as “NO FAVORITES CURRENTLY PLAYING” will be provided to inform the listener that a favorite was not found. This sub-routine will continue until a stored Favorite has been identified or the FAST button or the radio is turned off.

If at decision point 22 a stored Favorite has been found then radio 4 presents the designator information for that favorite artist/song title on display 26. An audible indicator may also be provided when the initial Favorite has been identified. This subroutine will loop, displaying additional favorites identified by the FAST feature on display 26. At a decision point 30 it is determined whether or not the listener has indicated their desire to listen to one of the found Favorites. If a button 16 has been pressed then the logic proceeds to a box 34 and directs the radio to begin playing the selected Favorite. If button 16 is not pressed the logic loops back to box 20 and continues scanning the frequency bands for Favorites.

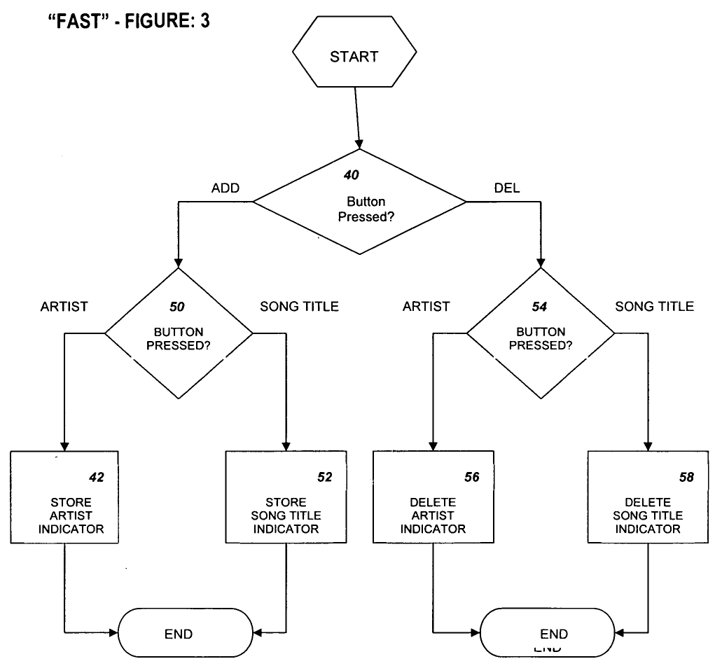

Referring now to FIGS. 1 and 3, the way in which favorite artist/song titles are stored to and deleted from the radio will be described. At a decision point 40 it is determined whether or not the ADD button 8 or the DELETE button 6 have been pressed. If Add button 8 has been pressed the logic directs the radio to decision point 50 to determine if Artist button 10 or Song Title button 14 is pressed. If Artist button 10 is pressed, the logic proceeds to box 42 “Store Artist Indicator”, storing the current Artist indicator information being broadcast by the radio station to a non-volatile memory in the radio. End of logic sub-routine. If Song Title button 14 is pressed, the logic proceeds to box 52 “Store Song Title Indicator”, storing the current Song Title indicator information being broadcast by the radio station to a non-volatile memory in the radio. End of logic sub-routine. The non-volatile memory can be the same as used to store favorite radio stations in conventional radios. Enough memory should be supplied to store information for a large number of favorite artist/song titles.

If DELETE button 6 has been pressed the logic directs the radio to decision point 54 to determine if Artist button 10 or Song Title button 14 is pressed. If Artist button 10 is pressed, the logic proceeds to box 56 “Delete Artist Indicator”, deleting the current Artist indicator information from the non-volatile memory in the radio. End of logic sub-routine. If Song Title button 14 is pressed, the logic proceeds to box 58 “Delete Song Title Indicator”, deleting the current Song Title indicator information from the non-volatile memory in the radio. End of logic sub-routine.

The FAST function can be used even if a compact disk (CD) or audio cassette is currently providing the audio to the radio.

The invention has been described with reference to a preferred embodiment. However, it will be appreciated that variations and modifications can be effected by a person of ordinary skill in the art without departing from the scope of the invention.

1. A method of selecting a favorite artist/song title from a plurality of broadcasts being transmitted from one or more remote locations to a radio, comprising the steps of:
storing a designator for the favorite artist/song title;
scanning a plurality of channels to determine if a favorite artist/song title is currently playing on at least one of the channels;
providing an indication when the favorite artist/song title is found to be playing on at least one of the channels; and
offering an option to select a favorite artist or song title currently being broadcast.

2. The method of claim 1, wherein the storing step is capable of storing designators for a plurality of favorite artists/song titles.

3. The method of claim 1, wherein the scanning step obtains the designator from a broadcast which is currently being transmitted to the Radio.

4. The method of claim 1, wherein the favorite artist/song title is an artist or song title broadcast by radio.

5. The method of claim 1, wherein said providing step provides the indication by displaying the designator.

6. The method of claim 1, wherein the designator is the name of the artist.

7. The method of claim 1, wherein the designator is the song title.

8. The method of claim 1, wherein the offering step allows the listener to select and listen to a favorite song.

9. An apparatus for selecting a favorite artist/song title from a plurality of broadcasts being transmitted from one or more remote locations to a radio, comprising the steps of:
a memory for storing a designator for the favorite artist/song title;
means for scanning a plurality of frequencies to determine if the favorite artist/song title is currently playing on a radio broadcast;
means for providing an indication when the favorite artist/song title is found to be playing on at least one of the channels; and
means for selecting a favorite artist or song title currently being broadcast.

10. The apparatus of claim 9, wherein the memory is capable of storing designators for a plurality of favorite artist/song titles.

11. The apparatus of claim 9, wherein the designator stored in the memory is obtained from a broadcast which is currently being transmitted to the radio.

12. The apparatus of claim 9, wherein the favorite artist/song title is a radio broadcast.

13. The apparatus of claim 9, wherein said providing means provides the indication by displaying the designator.

14. The apparatus of claim 9, wherein the designator is the name of the artist.

15. The apparatus of claim 9, wherein the designator is the name of the song title.

16. The apparatus of claim 9, wherein said selecting means allowing the listener to select and listen to a favorite song.

17. The apparatus of claim 9, wherein the apparatus includes a radio.
